(19) United States
(12) Patent Application Publication
(10) Pub. No.: US 2024/0336333 A1
(43) Pub. Date: Oct. 10, 2024

(54) PULL-IN OF DYNAMIC CABLES FOR FLOATING WIND TURBINES

(71) Applicant: Kongsberg Maritime AS, Kongsberg (NO)

(72) Inventors: Arild ÅNENSEN, Lysaker (NO); Kristian Ivar ØIEN, Kongsberg (NO); Lars Petter TENNFJORD, Ålesund (NO)

(21) Appl. No.: 18/294,091

(22) PCT Filed: Dec. 5, 2022
(86) PCT No.: PCT/NO2022/050278

§ 371 Date: Jan. 31, 2024

(30) Foreign Application Priority Data
Dec. 3, 2021 (NO) 20211513

(51) Int. Cl. B63B 21/50; B63B 21/16; B63B 35/44; B63B 79/15; B63B 79/40

(52) U.S. Cl. CPC B63B 21/50; B63B 21/16; B63B 79/15; B63B 79/40; B63B 2035/446

(57) ABSTRACT

Disclosed are systems for remote cable pull-in of a dynamic cable to a floating wind turbine from a vessel, the system including a floating wind turbine having a pull-in wire attachable to a dynamic cable to be connected to the floating wind turbine; a vessel for performing a dynamic cable pull-in operation for connecting the dynamic cable to the floating wind turbine, wherein the pull-in wire is attachable to the dynamic cable, the vessel is adapted for pulling the pull-in wire and the attached dynamic cable to the floating wind turbine, and wherein the system is adapted for compensating a relative movement between the vessel and the floating wind turbine during the pull-in operation.

### INTRODUCTION

The present invention concerns a system for remote cable pull-in of a dynamic cable to a floating wind turbine (FWT) from a vessel, a floating wind turbine (FWT), and a vessel for performing a pull-in operation of a dynamic cable on a FWT, as well as a method for pull-in of dynamic cables on floating wind turbines (FWTs).

### BACKGROUND

FWTs organized in floating wind turbine parks as illustrated in FIG. 1, or as individual FWTs, are typically connected to a subsea power cable for transporting the electrical energy harvested by the wind turbines to its destination which may e.g. be onshore, offshore or for export. The subsea export cable may be connected to an offshore converter or substation (OSS) and further connected to the electric grid. The wind turbines in the floating wind turbine park may be connected together by inter-array power cables. For export of the harvested electrical energy, the inter-array cables may be connected in strings to an offshore converter station or an offshore substation. The offshore substation typically serves to step up the voltage from the site distribution voltage to a higher voltage. For projects located far from the grid connection point, the electrical energy may be converted from AC to DC.

The capacity in inter-array power cables is typically 36 kV or 66 kV. High capacity cables or export cables may have up to 220 kV. The inter-array dynamic power cable of the wind turbine is typically connected to the subsea power cable in a transition joint. For a larger wind turbine park, the turbines may be connected to several “strings” towards the converter/sub-station before the power continues in the export cable. An inter-array cable may include a specific cross-section in the dynamical part of the cable with a transition joint against a reduced cross-section in the static part of the cable. The static part may be pre-installed and connected to the dynamic part in connection with the dynamic cable installation. Alternatively, it is possible to only have one dynamically dimensioned cross-section in the entire inter-array cable length between turbine a and turbine b, but this is a cost issue with respect to fabrication and installation.

The FWTs require dynamic, high-capacity submarine cable systems to collect and export the power generated. FWTs are typically moored to the seabed to keep them in a more or less stable position. Contrary to bottom fixed wind turbines, such as monopile wind turbines standing on the seabed in a fixed position, a FWT is floating and will thus be exposed to external forces like, wind, current and waves resulting in motions. During an installation process for a cable not only the installation vessel can be moving but also the FWT can be moving relative to the vessel. Thus, installation procedures to FWTs are generally much more challenging in terms of technical and safety issued to be solved compared to a fixed installed WT standing on the seabed. FWT motions and excursions in addition to waves and currents subject the inter-array dynamic power cables to significant dynamic stresses. Therefore, these inter-array dynamic cables must accommodate all movements and loading from the ocean in relation to the floating wind turbine and in addition the weight of the dynamic cable itself. The inter-array dynamic cables are sensitive to voltage and bending and the potential for damage high during installation of the inter-array dynamic cable on the FWT. The operation to install and connect an inter-array dynamic cable to a floating wind turbine can be complex and time consuming. The installation process is generally more complex and sensitive compared to an installation process on a bottom fixed wind turbine since a FWT is exposed to external forces and will react on external forces like waves, wind, current etc. Today's solutions for dynamic cable installation require personnel onboard the cable installation vessel and also access by the personnel onboard the floating wind turbine for winch control. For installation of an inter-array dynamic cable to a floating wind turbine, a pull-in winch for pulling in the inter-array dynamic cable may be pre-installed on the floating wind turbine (FWT) together with other necessary infrastructure and instrumentation. The pull-in winch may be either a permanent system left on the floating wind turbine or a temporary system demobilized after use. A support vessel with motion compensated gangway may be used for providing access to the FWT for the pull-in crew. A vessel with a 3D crane may be used to lift on/off the pull-in winch system if temporary installed on the FWTs. The motion compensated gangway and the 3D crane may allow for operation in a higher weather criterion (higher waves, more wind etc) and also provide a safer installation of the inter-array dynamic cable to the floating wind turbine.

For floating wind turbines going from demonstration and pilot projects to large-scale developments there is an industry need to develop new and improved methods to install and connect the inter-array dynamic cables to the floating wind turbines.

### SUMMARY OF THE INVENTION

The invention provides a system for remote cable pull-in of a dynamic cable to a floating wind turbine from a vessel.

The system comprising:
a floating wind turbine comprising:
   a pull-in wire attachable to a dynamic cable to be connected to the floating wind turbine;
a vessel for performing a dynamic cable pull-in operation for connecting the dynamic cable to the floating wind turbine, wherein the pull-in wire is attachable to the dynamic cable, the vessel is adapted for pulling the pull-in wire and the attached dynamic cable to the floating wind turbine, and
wherein the system is adapted for compensating a relative movement between the vessel and the floating wind turbine during the pull-in operation.

The system may be adapted to compensate for movement of the pull-in wire relative to the floating wind turbine as may result from a variable distance between the vessel and floating wind turbine caused by vertical and/or lateral motions of either the vessel and/or the floating wind turbine. The movement may be an axial movement.

The system may further comprise a first sensor for measuring the distance between the floating wind turbine and the vessel. The first sensor may be a distance sensor, preferably an optical sensor. A relative movement between the vessel and the floating wind turbine may be estimated indirectly by using data from at least two sensors, where at least one sensor is arranged on the vessel and the at least one second sensor is arranged on the floating wind platform. The at least two sensors may be absolute position sensors.

The vessel may be provided with a dynamic positioning system adapted for controlling the vessel based on at least one first input parameter. The dynamic positioning system controls position and heading of the vessel by using the vessel's own propellers/thrusters. A winch control system may be adapted for controlling a winch on the vessel based on at least one second input parameter. The winch control system may be provided on the vessel.

The at least one first input parameter may comprise at least one of:
position of the floating wind turbine;
position of the vessel;
motions of the floating wind turbine including at least one of heave, sway, surge, roll, pitch and yaw;
motions of the vessel including at least one of heave, sway, surge, roll, pitch and yaw;
position of the pull-in wire and the dynamic cable; and
tension in the dynamic cable;
tension in pull-in wire;
position of the pull-in wire relative to the FWT;
movement of the pull-in wire relative to the FWT;
position of the dynamic cable relative to the FWT;
movement of the dynamic cable relative to the FWT;
output from the winch control system.

The at least one second input parameter may comprise at least one of:
position of the floating wind turbine;
position of the vessel;
motions of the floating wind turbine including at least one of heave, sway, surge, roll, pitch and yaw;
motions of the vessel including at least one of heave, sway, surge, roll, pitch and yaw;
position of the pull-in wire and the dynamic cable; and
tension in the dynamic cable;
tension in pull-in wire;
position of the pull-in wire relative to the FWT;
movement of the pull-in wire relative to the FWT;
position of the dynamic cable relative to the FWT;
movement of the dynamic cable relative to the FWT;
output from the DP system.

Compensating the relative movement between the vessel and the floating wind turbine during the pull-in operation may be performed by the winch or by the winch and the dynamic positioning system.

The system may further comprise at least one inertial navigation system (INS). The system may further comprise at least one of a satellite navigation system or an inertial measurement unit. The inertial measurement unit may be at least one of a motion reference unit (MRU) and a motion gyro compass (MGC).

At least one second sensor for monitoring a hang-off area on the floating wind turbine for the dynamic cable may be provided. The second sensor may preferably be an optical sensor. The system may further include a first communication system adapted for communicating at least one sensor signal from the floating wind platform to the vessel; and a second communication system on the vessel for receiving the at least one sensor signal. The first communication system and the second communication system may be a marine broad band radio (MBR).

It is provided a system for remote cable pull-in of a dynamic cable to a floating wind turbine from a vessel. The system comprising a floating wind turbine comprising a pull-in wire attachable to a dynamic cable to be connected to the floating wind turbine. The system further comprising a vessel comprising a winch for performing a dynamic cable pull-in operation for connecting the dynamic cable to the floating wind turbine. The pull-in wire is attachable to the dynamic cable. The vessel is adapted for pulling the pull-in wire and the attached dynamic cable to the floating wind turbine by the winch which is controlled by a winch control system. The system for remote cable pull-in is adapted for compensating a relative movement between the vessel and the floating wind turbine during the pull-in operation through the winch and a winch control system which are adapted for compensating and controlling movements of the pull-in wire caused by relative movements between the vessel and the floating wind turbine during the pull-in operation.

The winch control system controls the winch based on at least one of a relative position between the vessel and the floating wind turbine, a velocity of the floating wind turbine relative to the vessel and an orientation between the floating wind turbine and the vessel. An instrumentation system provided on the floating wind turbine determines the relative position, velocity, and orientation between the vessel and the floating wind turbine and provides output data to the winch control system on the vessel.

The system may further include a dynamic positioning system adapted for compensating for winch tension. The winch tension is provided by external forces. The dynamic positioning system may further be adapted for compensating for environmental forces as e.g. wind, waves and currents.

The invention provides a floating wind turbine comprising: a pull-in wire attachable to a dynamic cable to be connected to the floating wind turbine; and, wherein the pull-in wire is attachable to a vessel for performing a pull-in operation of the dynamic cable to the floating wind turbine and wherein the vessel is adapted for compensating a relative movement between the floating wind turbine and the vessel during the pull-in operation. The cable may be compensated to allow a relative movement between the vessel and the floating wind turbine.

The vessel may be adapted to compensate for movement of the pull-in wire relative to the floating wind turbine as may result from a variable distance between the vessel and floating wind turbine caused by vertical and/or lateral motions of either the vessel and/or the floating wind turbine. The movement may be an axial movement.

The floating wind turbine may further be provided with a sensor for measuring the distance between the floating wind turbine and the vessel. The sensor may be a distance sensor. The floating wind turbine may further comprise at least one inertial navigation system (INS).

The floating wind turbine may further comprise at least one of a satellite navigation system and an inertial measurement unit, preferably being a motion reference unit (MRU) or a motion gyro compass (MGC). The floating wind turbine may further be provided with at least one sensor for monitoring a hang-off area for the dynamic cable. The sensor for monitoring the hang-off area may be an optical sensor. The at least one sensor may be adapted to provide a signal when the dynamic cable is in a final hang-off position. The floating wind turbine may further comprise a hang-off arrangement adapted for hang-off of the dynamic cable to be pulled-in and connected to the floating wind turbine. The hang-off arrangement may be adapted for hang-off of the dynamic cable to be pulled in and connected to the floating wind turbine without manual intervention. The hang-off arrangement may be adapted for automatic hang-off. The hang-off arrangement may be a mechanical hang-off arrangement. The hang-off arrangement may be a hang-off clamp arrangement. The hang-off arrangement may include a weak link system to release the cable in case of a mooring line failure and a large floating wind turbine drift-off. The floating wind turbine may further include a communication system, preferably a marine broad band radio (MBR), adapted for communicating at least one signal from the floating wind turbine to the vessel.

The invention provides a vessel for performing a dynamic cable pull-in operation for connecting a dynamic cable to a floating wind turbine provided with a pull-in wire, wherein the pull-in wire is attachable to the dynamic cable, the vessel comprising a winch adapted for pulling the pull-in wire for pulling in the dynamic cable to the floating wind turbine, wherein the vessel is adapted for compensating a relative movement between the floating wind turbine and the vessel during the pull-in operation. The cable may be compensated to allow a relative movement between the vessel and the floating wind turbine.

The vessel may be adapted to compensate for movement of the pull-in wire relative to the floating wind turbine as may result from a variable distance between the vessel and floating wind turbine caused by vertical and/or lateral motions of either the vessel and/or the floating wind turbine.

The movement may be an axial movement. The vessel may further include a sensor for measuring the distance between the floating wind turbine and the vessel.

The vessel may further be provided with a dynamic positioning system adapted for controlling the vessel based on at least one first input parameter. A winch control system may be adapted for controlling the winch based on at least one second input parameter.

The at least one first input parameter may further comprise at least one of:
position of the floating wind turbine;
position of the vessel;
motions of the floating wind turbine including at least one of heave, sway, surge, roll, pitch and yaw;
motions of the vessel including at least one of heave, sway, surge, roll, pitch and yaw;
position of the pull-in wire and the dynamic cable; and
tension in the dynamic cable;
tension in pull-in wire;
position of the pull-in wire relative to the FWT;
movement of the pull-in wire relative to the FWT;
position of the dynamic cable relative to the FWT;
movement of the dynamic cable relative to the FWT;
output from the winch control system.

The at least one second input parameter may further comprise at least one of:
position of the floating wind turbine;
position of the vessel;
motions of the floating wind turbine including at least one of heave, sway, surge, roll, pitch and yaw;
motions of the vessel including at least one of heave, sway, surge, roll, pitch and yaw;
position of the pull-in wire and the dynamic cable; and
tension in the dynamic cable;
tension in pull-in wire;
position of the pull-in wire relative to the FWT;
movement of the pull-in wire relative to the FWT;
position of the dynamic cable relative to the FWT;
movement of the dynamic cable relative to the FWT;
output from the DP system.

Compensating the relative movement between the vessel and the floating wind turbine during the pull-in operation may be performed by the winch or by the winch and the dynamic positioning system.

The vessel may be provided with a communication system, preferably a marine broadband radio (MBR), for receiving at least one sensor signal from the floating wind turbine.

The invention also provides a method for performing a cable pull-in of a dynamic cable to a floating wind turbine according to the system above. The method comprising: attaching the dynamic cable to a pull-in wire on the floating wind turbine, pulling the pull-in wire by the vessel until the dynamic cable is positioned in a hang-off arrangement on the floating wind turbine, and compensating a relative movement between the floating wind turbine and the vessel during the pull-in operation. The cable may be compensated to allow a relative movement between the vessel and the floating wind turbine. The pulling by the vessel may be performed by a winch on the vessel.

The system may be adapted to compensate for movement of the pull-in wire relative to the floating wind turbine as may result from a variable distance between the vessel and floating wind turbine caused by vertical and/or lateral motions of either the vessel and/or the floating wind turbine.

The movement may be an axial movement. The method may further comprise measuring a distance between the floating wind turbine and the vessel. The distance may be measured between an exit for the pull-in wire on the floating wind turbine and an entry for the pull-in wire on the vessel.

The method may further comprise controlling the vessel by a dynamic positioning system based on at least one first input parameter. The method may further comprise controlling the winch by a winch control system based on at least one second input parameter. The at least one first input parameter comprises at least one of:
position of the floating wind turbine;
position of the vessel;
motions of the floating wind turbine including at least one of heave, sway, surge, roll, pitch and yaw;
motions of the vessel including at least one of heave, sway, surge, roll, pitch and yaw;
position of the pull-in wire and the dynamic cable; and
tension in the dynamic cable;
tension in pull-in wire;
position of the pull-in wire relative to the FWT;
movement of the pull-in wire relative to the FWT;
position of the dynamic cable relative to the FWT;
movement of the dynamic cable relative to the FWT;
output from the winch control system.

The at least one second input parameter comprises at least one of:
position of the floating wind turbine;
position of the vessel;
motions of the floating wind turbine including at least one of heave, sway, surge, roll, pitch and yaw;
motions of the vessel including at least one of heave, sway, surge, roll, pitch and yaw;
position of the pull-in wire and the dynamic cable; and
tension in the dynamic cable;
tension in pull-in wire;
position of the pull-in wire relative to the FWT;
movement of the pull-in wire relative to the FWT;
position of the dynamic cable relative to the FWT;
movement of the dynamic cable relative to the FWT;
output from the DP system.

Compensating the relative movement between the vessel and the floating wind turbine during the pull-in operation is performed by the winch, or the winch and the dynamic positioning system.

The idea with this concept is to make on a floating and thus moving installation such as a FWT, a dynamic cable pull-in system that can be installed and operated from the vessel installing or performing pull-in of the inter-array dynamic cables. A vessel in the context of the present invention is floating and is substantially kept stationary by dynamic positioning. The vessel may however also perform the pull-in operation by use of an active winch without a DP system as explained above. Eliminating the need for a pull-in winch installed on each of the FWTs and reducing the need for personnel and equipment transfer to and from the FWTs during the construction phase, addresses an industry challenge. For a scale wind park, in particular a large scale wind park, the invented system with its outlined methodology will:
1. Reduce the overall inter-array dynamic cable installation cost.
2. Avoid personnel and heavy equipment transfers to and from the FWTs during cable pull-in and hang-offs and thereby improve safety.
3. Increase flexibility in the marine schedule by reducing the need for support vessel, and personnel coordination.
4. With easy retrofit on FWT and vessel reduce the mobilization time to perform a future disconnection/hook-up of cables.

The remote dynamic cable pull-in system according to the invention addresses industry challenges for dynamic cable installation and connection operations. The new solution provides a more standardized operation that is faster to install compared to today's solutions, reduces the need for equipment and personnel on the floater and reduces the need for ROVs in the operation.

The new solution provides increased safety in the operation providing the possibility for a synchronized DP system and winch control system. The DP control system may also be provided with systems for improved operational overview during a pull-in operation. The DP control system may be integrated with the winch control system for semi-automatic failure handling. The integration between the winch control system and the DP control system on the vessel may allow these systems to monitor each other. This provides increased operator awareness and ability to automatically trigger compensating actions in case of vessel DP or winch failure which increases operation safety and prevent damage to the power cable. For increased safety the DP system and the winch control system may be co-located on the vessel bridge.

The DP system with special enhanced mission execution functionality controls position and heading on the vessel. The DP system may have an interface for a dynamic position operator. This DP system also provides pay out/pay in instructions, setpoints from the dynamic position (DP)/dynamic position operator (DPO) system, and system status of the DP/DPO system to the winch control system. The winch control system may provide the DP/DPO system with data for the wire length, wire tension and system status of the winch control system. The winch control system may also be provided with a local human machine interface (HMI). The winch control system may receive speed and setpoints from the winch. The winch control system controls the winch based on the received instructions and data from the DP/DPO system, local HMI and winch.

The benefits with the new remote Dynamic Cable Pull-in solution include:
The dynamic cable pull-in and hang off operations can be performed faster and in higher sea states compared to known solutions, without compromising on safety.
The pre-mobilized equipment needed on the FWT is significantly reduced, and there is no need for a pull-in winch on the FWT.
The need for a secondary vessel to support the operation is significantly reduced, since the dynamic cable pull-in and temporary hang-off of the dynamic cable can be performed remotely from the cable installation/pull-in vessel without personnel on the FWT.
With a pre-installed messenger wire that can be picked up at the surface, the need for ROV is reduced.

Benchmark studies show significant cost reductions implementing the DP remote dynamic cable pull-in solution of the present invention.
Increased operability and productivity without compromising on operational safety.
Integrated DP and winch control for automated consistent vessel and winch operation with reduced human interaction.

### BRIEF DESCRIPTION OF DRAWINGS

Example embodiments will now be described with reference to the following drawings, where:

FIG. 1 illustrates three floating wind turbines 2 in an offshore wind turbine park, where the floating wind turbines are interconnected with inter-array power cables 3. The floating wind turbines are moored to the seabed by mooring lines and anchors 4.

FIG. 2 illustrates an example of a remote dynamic cable pull-in concept for installation of inter-array dynamic power cables on a floating wind turbine.

FIG. 3 illustrates example equipment on the floating wind turbine to enable installation of the inter-array dynamic cable to the floating wind turbine using the remote dynamic cable pull-in concept.

FIG. 4 illustrates an example of a pull-in winch system on the installation vessel.

FIG. 5 illustrates an example with enhanced functionality of the DP control system of the installation vessel including a dynamic working area for safe operation.

FIG. 6 illustrates a combined DP and winch control system which may also be operated manually by personnel onboard the installation vessel.

FIG. 7 illustrates an exemplary remote hang-off connection for the dynamic cable to be installed on the floating wind turbine.

FIG. 8 illustrates a concept integration between instrumentation on the floating wind turbine, the pull-in winch and the dynamic positioning system on the installation vessel.

FIG. 9 illustrates steps (1)-(4) in a “direct cross-haul” of the first inter array dynamic cable end at the first floating wind turbine.

FIG. 10 illustrates steps (5)-(7) in a “direct cross-haul” of the first inter array dynamic cable end at the first floating wind turbine.

FIG. 11 illustrates steps (8)-(10) in a “direct cross-haul” of the first inter array dynamic cable end at the first floating wind turbine.

FIG. 12 illustrates an example of the inter array dynamic cable installation between a first and a second floating wind turbine.

FIG. 13 illustrates an example of a vessel approach for inter-array dynamic cable pull-in and hang-off at the second floating wind turbine.

FIG. 14 illustrates an example of steps for a cross-haul operation of the inter-array dynamic cable at the second floating wind turbine, where the installation vessel is initially positioned close to the second floating wind turbine to perform inter-array cable cross-haul with pre-installed messenger wire connected to the floating wind turbine.

FIG. 15 illustrates an example of steps for a pull-in and hang-off operation of the second inter-array dynamic cable end at the second floating wind turbine, where the inter-array dynamic cable is pulled in through a guide tube on the floating wind turbine and the cable hang-off on the floating wind turbine.

FIG. 16 illustrates an example of the last step of a pull-in and hang-off operation of the second inter-array dynamic cable end at the second floating wind turbine where the messenger wire is disconnected from the pull-in system and is free from the installation vessel.

FIG. 17 illustrates an example of steps for a recovery and pull-in operation where the inter-array dynamic cable is recovered from a wet store at the seabed.

### DETAILED DESCRIPTION

Example embodiments are described with reference to the drawings. The examples are not to be considered as limiting for the invention. The same reference numerals are used for the same or similar features in all the drawings and throughout the description.

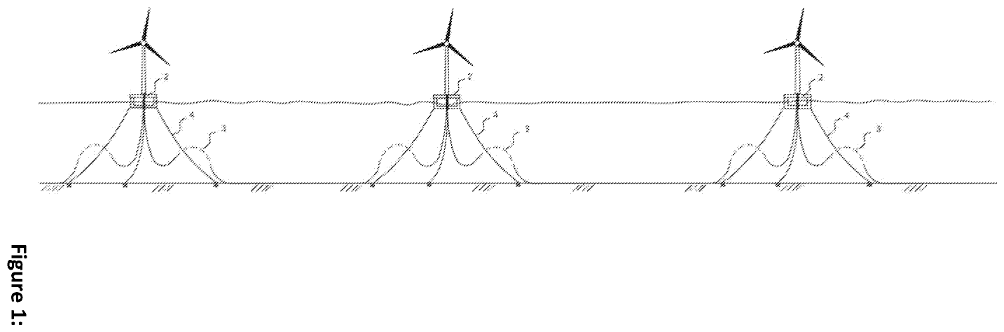

FIG. 1 illustrates three floating wind turbines 2 in an offshore wind turbine park. The floating wind turbines are interconnected with inter-array power cables 3. The floating wind turbines are moored to the seabed by mooring lines and anchors 4.

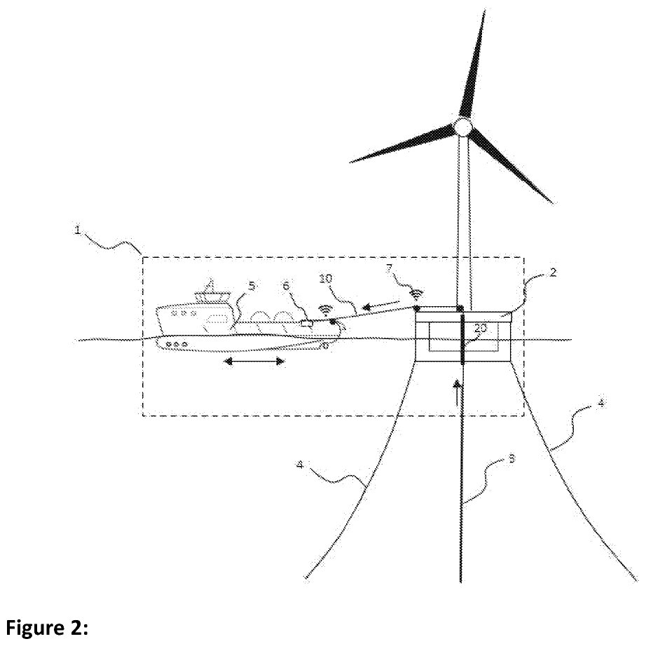

FIG. 2 illustrates an example of a remote dynamic cable pull-in concept for installation of inter-array dynamic power cables on a floating wind turbine. FIG. 2 illustrates a system for remote cable pull-in of a dynamic cable 3 to a FWT 2 from a vessel 5. The floating wind turbine 2 may be provided with a pull-in wire 10 attachable to a dynamic cable 3 to be connected to the floating wind turbine 2. The FWT may also be provided with a hang-off arrangement for the dynamic cable 3 attachable to the floating wind turbine 2. The hang-off arrangement will be described in detail later. The system may also include a vessel 5 for performing a dynamic cable pull-in operation for connecting the dynamic cable 3 to the floating wind turbine 2, wherein the pull-in wire is attachable to the dynamic cable 3. The vessel 5 may be provided with a winch 6 adapted for pulling the pull-in wire and the attached dynamic cable 3 to the floating wind turbine. The system may be adapted for compensating a relative movement between the vessel 5 and the floating wind turbine 2 during the pull-in operation. Relative movement may e.g. be wave or current induced and/or caused as the vessel decides to move.

The system may be adapted to compensate for movement on the pull-in wire by the relative distance between the FWT 2 and the vessel 5, and the vertical and/or sideways motions of FWT 2 and the vessel 5. This enables to synchronize a movement of the pull-in wire with a movement of the floating wind turbine 2.

A first sensor for measuring the distance between the floating wind turbine and the vessel may be provided on the FWT and/or the vessel. The first sensor may typically be a distance sensor. The distance sensor may be an optical sensor. The optical sensor may be a laser or IR sensor. Other distance sensors like radar or ultrasound may also be used depending on the system and system requirements.

A relative movement between the vessel 5 and the floating wind turbine 2 may alternatively be estimated indirectly by using data from at least two sensors, where at least one sensor is arranged on the vessel 5 and at least one sensor is arranged on the floating wind platform 2. The at least two sensors may be absolute position sensors.

The vessel 5 may be provided with a dynamic positioning system 51. Dynamic positioning (DP) involves automatic or semi-automatic control of a vessel's position and heading by using its own propellers and thrusters with respect to one or more position references. The dynamic positioning (DP) system may keep the position of the vessel fixed within given parameters or manoeuvre the vessel in a way that it could not do without the dynamic positioning system. A dynamic positioning (DP) system may manoeuvre a vessel based on a number of input parameters. These input parameters may e.g. come from:
sensors for location, heading, speed;
sensors for external factors such as wind, waves, current; and
input from a user to execute a mission such as maintain position or move in a particular pattern.

Control algorithms of the dynamic positioning (DP) system takes in the sensor and user input parameters and executes manoeuvre of the vessel by controlling the on-board propellers and thrusters even with changes in external forces.

The DP system may be adapted for controlling the vessel 5 based on at least one first input parameter, which may comprise at least one of:
position of the floating wind turbine;
position of the vessel;
motions of the floating wind turbine including at least one of heave, sway, surge, roll, pitch and yaw;
motions of the vessel including at least one of heave, sway, surge, roll, pitch and yaw;
position of the pull-in wire and the dynamic cable; and
tension in the dynamic cable;
tension in pull-in wire;
position of the pull-in wire relative to the FWT;
movement of the pull-in wire relative to the FWT;
position of the dynamic cable relative to the FWT;
movement of the dynamic cable relative to the FWT;
output from the winch control system.

A winch control 61 system is adapted for controlling the winch 6 on the vessel based on at least one second input parameter, which may comprise at least one of:
position of the floating wind turbine;
position of the vessel;
motions of the floating wind turbine including at least one of heave, sway, surge, roll, pitch and yaw;
motions of the vessel including at least one of heave, sway, surge, roll, pitch and yaw;
position of the pull-in wire and the dynamic cable; and
tension in the dynamic cable;
tension in pull-in wire;
position of the pull-in wire relative to the FWT;
movement of the pull-in wire relative to the FWT;
position of the dynamic cable relative to the FWT;
movement of the dynamic cable relative to the FWT;
output from the DP system.

The system may be provided with at least one inertial navigation system (INS) 13, which may be a satellite navigation system or an inertial measurement unit. The inertial measurement unit may be at least one of a motion reference unit (MRU) and a motion gyro compass (MGC).

The vessel may or may not be provided with a dynamic positioning system.

If the vessel is not provided with a DP system, the example concept system includes a winch on the vessel and instrumentation on the floating wind turbine. By communicating with the instrumentation on the floating wind turbine, the winch compensates for the motions of the floating wind turbine and the vessel. This enables to control the motion of the pull-in wire relative to a guide tube for the dynamic cable on the floating wind turbine. The winch is an active winch able to compensate for the movements both on the vessel and the floating wind turbine (FWT). The active winch is controlled by a winch control system. The position of the vessel may e.g. be controlled manually in “joystick” mode. The instrumentation system determines the relative position, velocity, and orientation between the vessel and the floating wind turbine and provides output data to the winch control system on the vessel. The winch control system is adapted for accurate compensating and controlling cable movements caused by relative movements between the vessel and the floating wind turbine during the pull-in operation by using sensor data from the vessel and the floating wind turbine. The determination may be provided in real time and the data may provide continuous outputs to the winch control system. The determination may be provided in near real time or at intervals and the data may provide nearly continuous or intermittent outputs to the winch control system depending on the requirements of the operation. One part of the system (vessel processing unit) is installed on the vessel and another part (remote motion system) on the floating wind turbine. The two parts of the system may communicate through Marine Broadband Radio (MBR) data link.

In the case the vessel is provided with a DP system, the example concept includes a winch on the vessel, a DP control system and instrumentation on the floating wind turbine. The winch is controlled by a winch control system. The DP control system and the winch control system are adapted to optimally compensate for the relative movement between the vessel and the FWT during cable pull-in. The instrumentation system determines the relative position, velocity, and orientation between the vessel and the floating wind turbine and provides output data to the DP system and winch control system on the vessel. The determination may be provided in real time and the data may provide continuous outputs to the DP system and winch control system. The determination may be provided in real time and the data may provide continuous outputs to the winch control system. The determination may be provided in near real time or at intervals and the data may provide nearly continuous or intermittent outputs to the winch control system depending on the requirements of the operation. The vessel DP system compensates for winch tension (external force) in addition to environmental forces. A vessel processing unit on the vessel may receive real time position from the floating wind turbine and calculate relative position, velocity and orientation and output these data to the DP and winch control system. A remote motion system is provided on the floating wind turbine. The remote motion system may include an inertial measurement unit, processing unit, battery. The remote motion system and the vessel processing unit may communicate through a Marine Broadband Radio (MBR) data link. Further details of these systems are explained later.

If the vessel is provided with a dynamic positioning (DP) system, measuring movements in 2×6 degrees-of-freedom (DOF) and compensating movements in 2×6 degrees-of-freedom (DOF) is accomplished by synchronizing the DP control system and the winch control system. The DP control system and the winch control system are synchronized to maintain safety margins during an operation where the vessel and the floating wind turbine are connected together. The DP control system and the winch control system is adapted to optimally compensate for the relative movement between the vessel and the FWT during cable pull-in. Synchronization of the DP control system and the winch control system may involve at least one of position of floating wind turbine (e.g, measured with sensors on the floating wind turbine), position of vessel provided by the dynamic positioning system, position of the pull-in cable provided by the winch/winch control system and operational status of the DP system and the winch/winch control system. The DP control system and the winch control system work together and know each other's operation based on the input parameters described and listed above. Each of the DP control system and the winch control system also knows the status of the other system. Status may be in the form of fault/error conditions or whether the systems operate as normal. This may be used to improve the security of the system if faults/errors happen. If one of the DP control system or winch control system fails during operation, i.e. if not able to keep precise position of vessel and pull-in wire, the remaining operational control system (DP or winch control system) will move the vessel and wire to a position with increased safety margins. The pull-in wire (with attached dynamic cable) may e.g. be brought into a safe position, the operation reversed or the operation aborted.

### Some Examples of Failures of Winch or DP System:

Example a): Winch is locked and cannot compensate-> Vessel then moves closer to the FWT to lower the dynamic power cable and keep it away from a critical position near the FWT.
Example b): DP fails and vessel looses position-> Winch will pay out the pull-in wire to lower the dynamic cable to seabed and prepare for emergency disconnect.

As explained above, FIG. 2 illustrates an example remote dynamic cable pull in concept 1 for a floating wind turbine (FWT) 2. The cable to be pulled in is an inter-array dynamic cable 3 to be connected to the floating wind turbine 2. The floating wind turbine may be part of an offshore wind turbine plant. As earlier explained, inter-array dynamic cables are sensitive to voltage and bending, and the potential for damage is high during installation. The floating wind turbine 2 is in the example in FIG. 2 provided with a guide tube 20 for the inter array dynamic cable 3. Floater instrumentation kit 7 as described in detail below is provided for monitoring the messenger wire 10.

An installation vessel 5 may be provided with a dynamic positioning system (DP) and a pull-in winch 6. The winch 6 is provided with a winch control system. The winch control system is arranged on the vessel 5. The winch control system is connected to the DP control system for providing winch parameters to the DP control system and for control of the winch 6 by the DP control system. The DP system may be integrated with the winch control system. The integration of the systems may provide an operator of the integrated DP and winch control system with improved operational overview.

The pull-in winch 6 pulls in the messenger wire/pull-in wire 10 connected to the inter array dynamic cable 3 through the guide tube 20. The messenger wire/pull-in wire 10 passes over rollers or sheaves on the floating wind turbine deck that support and guide the messenger wire/pull-in wire 10. Rollers and sheaves may also be provided on the installation vessel 6 to support and guide the messenger/pull-in wire 10 when it comes onboard and further on the vessel deck before reaching the pull-in winch 6. The installation vessel 5 and the floating wind turbine 2 are provided with wireless communication for communicating signals from the instrumentation on the floating wind turbine 2 to the installation vessel 5.

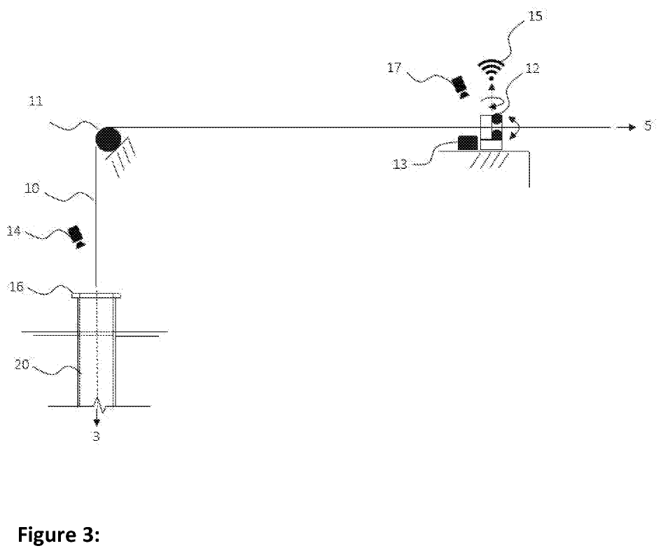

An example of equipment typically provided on the floating wind turbine 2 is illustrated in FIG. 3. A first sheave/guide 11 is arranged to centralize the messenger/pull-in wire 10 in the guide tube 20 on the floating wind turbine. The sheave/guide 11 is arranged above the guide tube hang-off 16. A second sheave/guide 12 is arranged to support and deflect the messenger wire from the floating wind turbine 1 before the messenger wire 10 exits the floating wind platform and passes on to the installation vessel 5. A topside guide tube hang-off arrangement 16 for remote cable hang-off is provided on the top of the guide tube 20. This is where the messenger wire and the inter array dynamic cable 3 exits the guide tube 20. One or more sensors may be provided for monitoring a hang-off area for the dynamic cable 3. The sensor may be a distance sensor e.g. in the form of a laser or IR sensor or radar. The sensor may be an optical sensor, e.g. a camera or video camera. A first camera 14 may be arranged to monitor the dynamic cable hang-off area. A second camera 17 may be arranged to monitor the messenger wire 10 in the further sheave/guide 12. The second camera 17 may also monitor the exit of the messenger wire from the further sheave/guide 12. The first and second camera may e.g. be a video camera. The FWT may be provided with at least one sensor adapted to provide a signal when the dynamic cable is in a final hang-off position.

The floating wind turbine may be provided with an Inertial Navigation System (INS) 13. The Inertial Navigation System 13 may include at least one of a satellite navigation system (e.g. Global Navigation Satellite System (GNSS) or GPS) and an Inertial Measurement Unit (MRU or MGC) to measure position and movements of the floating wind turbine 2. The satellite navigation system may e.g. be GNSS, GPS, GLOANASS, BeiDou, Galileo, QZSS, IRNASS or NavIC. The Inertial Navigation System (INS) may be attached near the second sheave/guide 12 where the messenger wire exits the floating wind turbine. This enables monitoring of the floating wind turbine's movements; i.e. heave, sway, surge, roll, pitch and yaw. The floating wind turbine 2 may further be provided with a communication system (transceiver) 15 for communication of the signals from the floating instrumentation, e.g. signals from the Inertial Navigation System (INS), sensors and cameras, onboard the floating wind turbine to the installation vessel. The communication system may e.g. be a Marine Broadband Radio (MBR), but other wireless communication systems may also be used. The instrumentation on the floater may be pre-installed. The installation on the floater may be removable.

Also, the messenger wire/pull-in wire 10 may be pre-installed on the floating wind turbine 2. The floating wind turbine may be provided with a distance sensor for measuring a relative distance between the floating wind turbine 2 and the vessel 5. The distance sensor may e.g. be a laser, IR sensor, ultrasound sensor or radar.

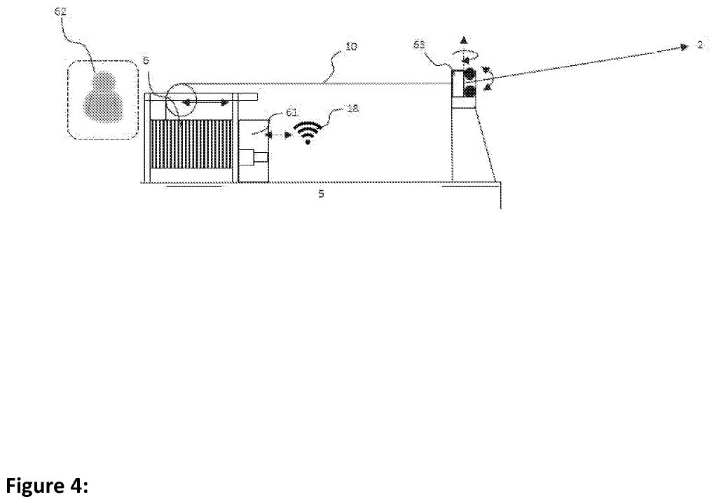

The pull-in winch system on the installation vessel 5 may be fitted at different positions and with various sheave arrangements to route and support the pull-in wire (e.g. see FIG. 4). This allows for the concept to be implemented into different vessel lay spreads; e.g. Horizontal Lay Spread (HLS) with dynamic cable installed over the stern or over the side, Vertical Lay Spread (VLS) with dynamic cable installed though moonpool or over side.

The messenger wire on the floating wind turbine may be pre-installed in different arrangements for release and connection to the dynamic cable and pull-in winch. A hang-off arrangement may also be incorporated in the messenger wire arrangement to be able to temporary hang-off the dynamic cable and release the pull-in winch wire in case of an abandonment.

The remote cable hang-off onboard the floating wind turbine 2 may be a mechanical arrangement, a mechanism incorporated in the hang-off clamp design, a mechanism incorporated in the hang-off flange, or a combined clamp and hang-off flange mechanism. The combined hang-off flange mechanism may be a remote operated connector design similar to a diverless bend stiffener connector. Hang-off of the dynamic cable 3 to be pulled-in and connected to the floating wind turbine 2 may be performed without manual intervention. An automatic hang-off enables performing hang-off operations without personnel on the floater. An example may be use of a system with three latching dogs rotating and gripping into a groove or support in the cable termination head. The three latching dogs are mounted on top of a guide tube. The latching dogs may include a weak-link releasing the cable from the floating wind turbine in case of a large floating wind turbine drift-off e.g. due to a mooring line failure.

The pull-in winch 6 on the installation vessel 5 is illustrated in more detail in FIG. 4. The pull-in winch (PIW) is provided with a PIW control system 61. The control system 61 may also have a back-up in the form of human personnel 62 (PIW local HMI) onboard the installation vessel 5 that may manually control the pull-in winch.

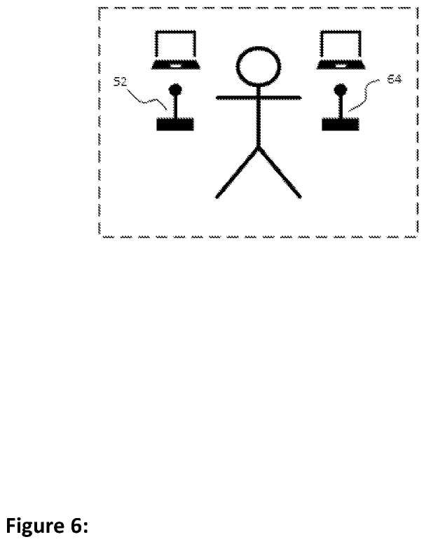

The control system is connected to a communication system 18 for communicating with transceiver 15 on the floating wind turbine. The communication system may be a Marin Broadband Radio (MBR). The equipment on the installation vessel may also include a sheave/guide arrangement 63 to support and deflect the messenger/pull-in wire 10. The sheave/guide arrangement may allow the vessel to optimize position and heading. The dynamic positioning system (DP) 51 (FIG. 6) on the installation vessel 5 may also be provided with a special enhanced mission equipment functionality to control the installation vessel 5 during the dynamic cable pull-in operation also based on input from the sensor systems on the floating wind turbine 2. The dynamic positioning system 51 on the installation vessel 5 may have a communication module to enable communication with the pull-in winch control system 61 and for controlling the pull-in winch control system 61. As a security system in case of system failure, the DP system and the pull-in winch control system may be provided with manual controls 52, 64 for control by human personnel onboard the installation vessel 5.

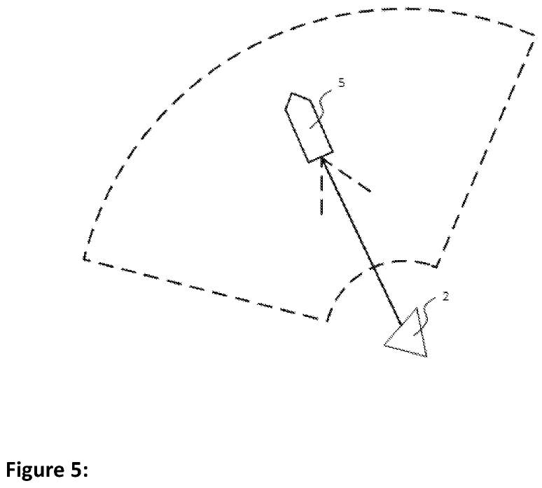

FIG. 5 is an example of how the DP control system on the installation vessel 5 may include a working area definition where it is safe to position the installation vessel in the current operation step. When the installation vessel is connected directly to the dynamic cable, the working area is defined by limits that avoids damaging the dynamic cable by for instance bending or dragging. After the dynamic cable is connected to the messenger/pull-in wire, the position and heading limits of the installation vessel are defined by the operation angles and length of the pull-in winch. The defined limits can be used by the DP control system to prevent the operator from moving the installation vessel or heading outside the safe operation area. Alarms and warnings may also be issued to the operator if the installation vessel approaches these limits.

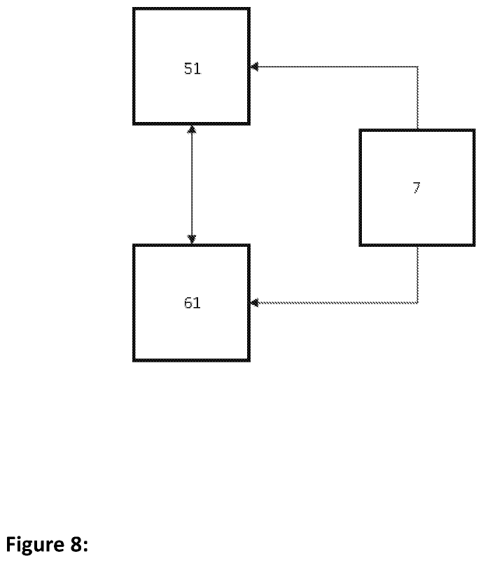

The floating wind turbine 2 (FWT) instrumentation, the vessel pull-in winch (PIW) system 6 and the dynamic positioning (DP) system 51 of the installation vessel 5 work together to accomplish the mission of the pull-in operation procedure of the inter-array dynamic cable onboard the floating wind turbine 2. FIG. 8 illustrates this concept of integration between the instrumentation kit 7 of the floating wind turbine 2, the pull-in winch 6 and the dynamic positioning system 51. The floating wind turbine 2 instrumentation measure the floating wind turbine's 2 position and movements (heave, sway, surge, roll, pitch, yaw). These position and movement parameters are transmitted to the installation vessel 5. The pull-in winch 6 control system 61 and the dynamic positioning system 51 receive the position and movement parameters from the instrumentation 7 on the floating wind turbine. The dynamic positioning system 51 controls the installation vessel 5 based on a number of parameters including the position of the installation vessel and the position and movement parameters from the instrumentation 7 on the floating wind turbine and compensates the relative movements between the floating wind turbine 2 and the installation vessel to enable a controlled cable pull-in and hang-off operation. The dynamic positioning system 51 also provides input parameters to the winch control system 61 controlling the pull-in winch 6 as illustrated in FIG. 8.

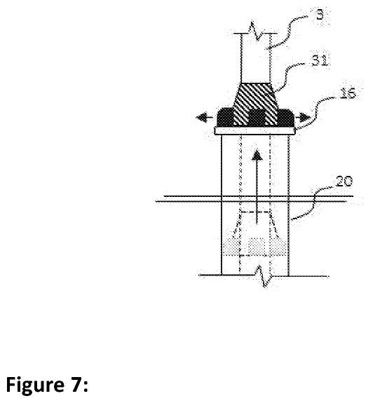

The integration of the winch control system 61 with the vessel DP system 51 enables to perform coordinated vessel positioning and winch pay-out/pay-in operation, and also to increase the overall safety in case of a vessel DP incident or winch failure. To perform a dynamic cable pull-in operation with no personnel onboard, the floating wind turbine 2 has in addition a pre-installed messenger wire 10 routed through the guide tube 20 and sheave arrangements 11, 12 as described above. To perform a dynamic cable hang-off operation with no personnel onboard the floating wind turbine 2 is provided with an automatic hang-off clamp arrangement 31. The automatic hang-off clamp arrangement may be placed on the floater topside, and may typically be placed on the topside of the guide tube 16 end of which an example is shown in FIG. 7.

FIG. 7 illustrates an example of an automatic hang-off arrangement on the FWT. The guide tube 20 is provided with a topside hang-off flange arrangement/interface 16 for remote cable hang-off. The inter array dynamic cable 3 may be provided with a hang-off clamp with a spring-loaded latch arrangement 31. When the inter array dynamic cable 3 is pulled up through the guide tube 20 and exits the topside of the guide tube 16, the spring-loaded latch arrangement 31 expands and secures the inter array dynamic cable 3 in position on top of hang-off plate and prevent the inter array dynamic cable from slipping back down into the guide tube 20. Further functions of the guide tube when guiding the cable in a pull-in operation will be described.

FIG. 8 illustrates a concept integration between the instrumentation kit 7 on the floating wind turbine 2, the pull-in winch 6 and the dynamic positioning (DP) system 51 on the installation vessel. The instrumentation on the floating wind turbines share information about the floating wind turbine position and floating wind turbine motions to the control system 61 of the winch and to the dynamic positioning system. The pull-in winch may send information about the messenger wire/pull-in wire length and messenger wire/pull-in wire tension to the DP system 51. The pull-in winch control system 61 may receive messenger wire/pull-in wire length setpoints from the dynamic positioning (DP) system 51. The winch control system receives separate signals for vessel motion, motion of the floating wind turbine and relative motion from the remote motion system on the floating wind turbine.

A method for performing a cable pull-in of a dynamic cable to a floating wind turbine for the system described above is disclosed. The dynamic cable is attached to a pull-in wire on the floating wind turbine. Pulling the pull-in wire by the vessel is performed until the dynamic cable is positioned in a hang-off arrangement on the floating wind turbine. The pulling of the pull-in wire may be performed by moving the vessel by towing and/or by hauling in the pull-in wire. The hauling in may be performed by use of a winch or by use of sheaves (e.g. as in a heave compensation system). The sheaves perform dynamic compensation. The winch may be controlled dynamically. A relative movement between the floating wind turbine and the vessel is compensated during the pull-in operation.

The system is adapted to compensate for movement on the pull-in wire by a relative distance between the floating wind turbine 2 and the vessel 5 and the vertical motions of the floating wind turbine 2 and the vessel 5. To control the pull-in operation a distance may be measured between the floating wind turbine and the vessel. The distance may be measured between an exit for the pull-in wire on the floating wind turbine and an entry for the pull-in wire on the vessel. The exit/entry points may be departing point/entry points or vice versa depending upon the circumstances. The vessel may be controlled by a dynamic positioning system based on at least one first input parameter. The winch may be controlled by a winch control system based on at least one second input parameter. The at least one first input parameter comprises at least one of, position of the floating wind turbine, position of the vessel; motions of the floating wind turbine including at least one of heave, sway, surge, roll, pitch and yaw; position of the pull-in wire and the dynamic cable; motions of the vessel including at least one of heave, sway, surge, roll, pitch and yaw; and tension in the dynamic cable; tension in pull-in wire; position of the pull-in wire relative to the FWT; movement of the pull-in wire relative to the FWT; position of the dynamic cable relative to the FWT; movement of the dynamic cable relative to the FWT; output from the winch control system. The at least one second input parameter comprises at least one of: position of the floating wind turbine; position of the vessel; motions of the floating wind turbine including at least one of heave, sway, surge, roll, pitch and yaw; motions of the vessel including at least one of heave, sway, surge, roll, pitch and yaw; position of the pull-in wire and the dynamic cable; and tension in the dynamic cable; tension in pull-in wire; position of the pull-in wire relative to the FWT; movement of the pull-in wire relative to the FWT; position of the dynamic cable relative to the FWT; movement of the dynamic cable relative to the FWT; output from the DP system.

### Cable Pull-In Operation

As mentioned above, the cables are sensitive to voltage and bending and the pull-in procedure must be performed with care. A cable pull-in performed onboard the floating wind turbine limits tension monitoring to heave/excursions on the floating wind turbine. Pull-in from a vessel is known from bottom fixed turbines, where tension monitoring is limited to the vessel's heave/excursions (if operated on DP). Pull-in to a floating wind turbine from a vessel may involve monitoring and compensation for relative distance/movements of both the vessel and the floating wind turbine. As explained before, contrary to bottom fixed wind turbines, a floating wind turbine (FWT) is floating and will thus be exposed to external forces like, wind, current and waves resulting in motions. During an installation process for a cable not only the installation vessel is moving but also the FWT is moving relative to the vessel. The cables are vulnerable to small radius bending and tension which imposes heavy demands on the operation and the equipment involved in the operation. Thus, installation procedures to FWTs are generally much more challenging in terms of technical and safety issues to be solved compared to a fixed installed wind turbine standing on the seabed. The described pull-in solution includes automated systems for coordinating floater movements, pull-in winch and DP set points (if vessel is a DP vessel) during normal operation and during contingency scenarios.

### Direct Cross-Haul of the First Inter Array Dynamic Cable End at the First Floatinq Wind Turbine

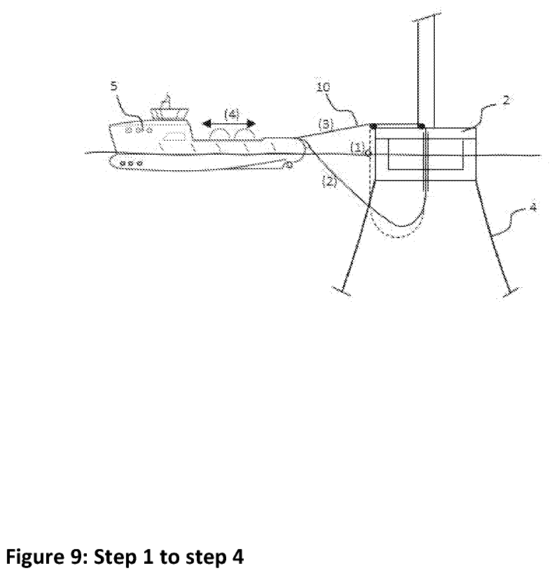

FIG. 9 illustrates the different steps (1)-(4) shown in brackets in FIG. 9 preparing for performing a direct cross-haul of a first inter array dynamic cable end at the first floating wind turbine 2 by the installation vessel 5. The floating wind turbine has mooring lines 4 for attachment to the seabed.

At the start of the operation, the installation vessel may be positioned close to the floating wind turbine. Operation tasks in step (1) to step (4) in FIG. 9:
1. The installation vessel 5 may pick up the pre-installed messenger wire 10 on the floating wind turbine on the sea surface or the messenger wire 10 may be picked up below the sea surface by an ROV.
2. The messenger wire end routed subsea is picked up by the installation vessel or ROV and connected onboard the installation vessel to the topside of the inter array dynamic cable 3 onboard the installation vessel 5.
3. The messenger wire end routed topside on the floating wind turbine is connected to vessel pull-in winch 6.
4. The vessel position and heading are optimized within procedure limits for cross-hauling the inter array dynamic cable 3 to the floating wind turbine 2.

The installation vessel is now ready to perform the cross-haul of the first inter array dynamic cable to the first floating wind platform.

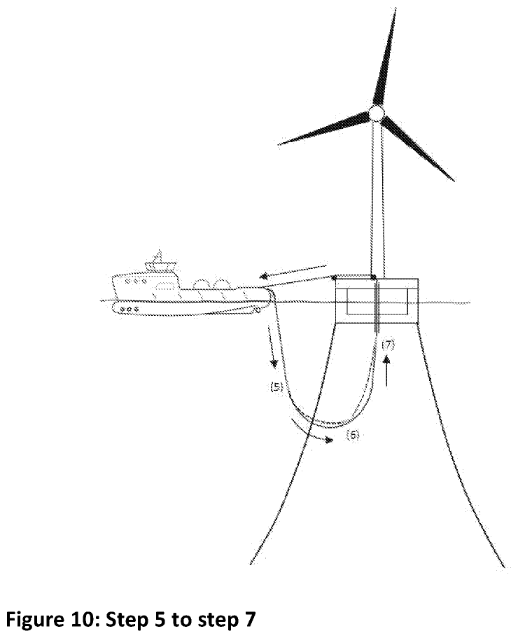

### Operation Steps (5)-(7) in FIG. 10:

5. The first end of the inter array dynamic cable is deployed from installation vessel to cross haul depth. The cable is sensitive to bending and a cross haul depth is determined that provides an acceptable bending of the cable without damaging the cable.
6. Continue pay out on cable from installation vessel 5 and start to pull-in first end of cable with pull-in winch 6. The mission may have a lay table for each dynamic cable. The lay table is a detailed description of the positions and movements of the installation vessel, the dynamic cable pay-in/pay-in, the winch pay-out/pay-in based on analysis of the mission. The lay table is followed by the operator of the installation vessel and/or may be programmed into the dynamic positioning system. The subsea operation is typically monitored by an ROV.
7. Continue to pull-in cable by the pull-in winch and monitor topside end by camera 14 when the cable enters the bottom of the guide tube 20. The installation vessel position is adjusted and pay out of cable performed to ensure correct entering of the cable into the guide tube 20.

Pull-in and hang-off of the inter array dynamic cable on the floating wind turbine can now be performed.

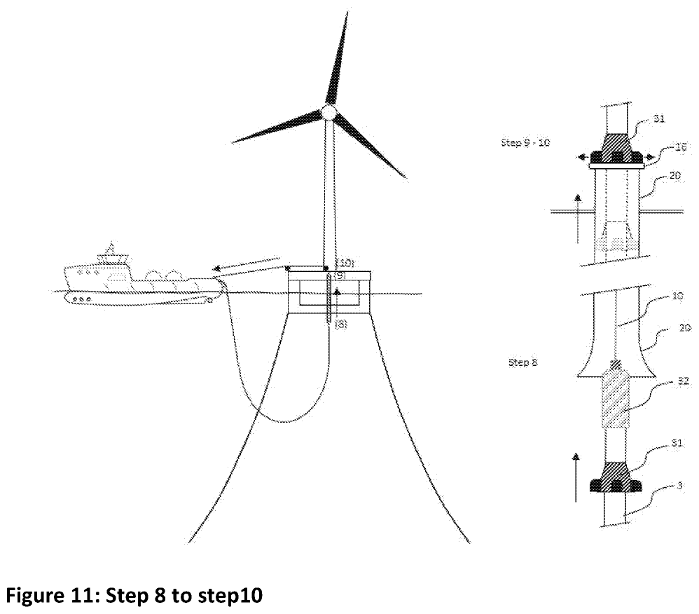

FIG. 11a illustrates the different steps (8)-(10) shown in brackets for a pull-in and hang-off of a first inter array dynamic cable end at the first floating wind turbine 2 by the installation vessel 5. FIG. 11b also shows the cable 3 with hang-off clamp when entering the guide tube 20 attached to the pull-in wire 10 in step (8) and after hang-off clamp 31 has been pulled through and above the guide tube resting on the topside hang-off flange/interface 16 (step (9)-(10)).

### Operation Steps (8)-(10):

8. The installation vessel continues to pull-in the cable topside end into the guide tube, monitoring cable carefully when entering the bottom guide tube. The bottom of the guide tube may be provided with a bellmouth or alternative bend stiffener connector (not shown). For dynamic cables one bed stiffener arrangement may be appropriate for FWTs.
9. Continue to pull-in cable until hang-off clamp is pulled through the guide tube and above the topside hang-off flange/interface, monitored by topside camera—followed by stop of pull-in.
10. Lower hang-off clamp with extracted latches down on the hang-off flange/interface.

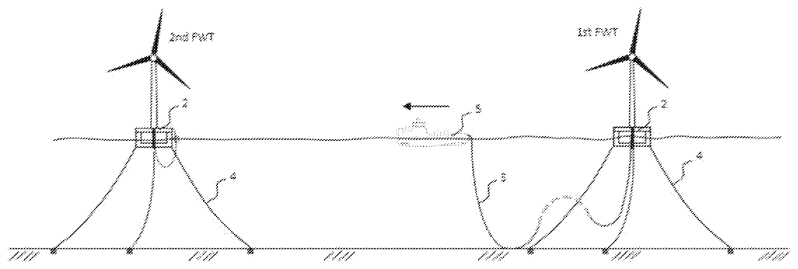

After the first inter array dynamic cable pull-in and hang-off are completed, the installation vessel disconnects the pull-in winch wire at the first floating wind turbine and continues installing the inter array cable towards the second FWT as illustrated in FIG. 12.

Until the hang-off clamp is pulled past the guide tube hang-off flange/interface, the pull-in operation can be reversed. After this point the installation vessel will continue to install the inter array cable.

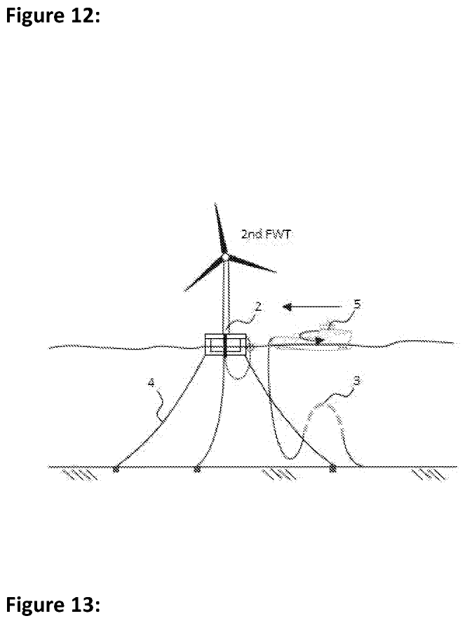

The approach for inter-array dynamic cable pull-in and hang-off at the second floating wind turbine are illustrated in FIG. 13.

The installation vessel 5 is positioned close to the floating wind turbine 2 to perform inter-array dynamic cable pull-in and hang-off at the second floating wind turbine. Approaching the second floating wind turbine 2, the installation vessel 5 rotates ending up with the bow of the installation vessel pointing away from the floating wind turbine and with the stern towards the floating wind turbine. The installation vessel then backs towards the floating wind turbine with the stern first. The method in FIG. 13 is illustrated for a horizontal lay system with a chute over the stern of the vessel. This implies that the vessel must rotate and back towards the floater stern first as described above. The illustrated method in FIG. 13 is an alternative and other methods may be possible depending on the floating installation and the vessel.

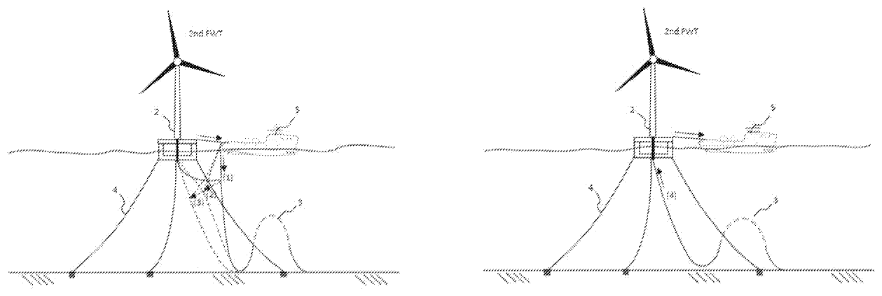

FIG. 14 illustrates a cross-haul of the inter array dynamic cable 3 end at the second floating wind turbine 2.

In FIG. 14, the installation vessel is positioned close to the floating wind turbine to perform inter-array dynamic cable cross-haul operation tasks.

The installation vessel has deployed the inter-array cable 3 from the 1st floating wind turbine towards the second floating wind turbine. The subsea routed end and the topside routed end of the pre-installed messenger wire is picked up and connected similar to the steps in FIG. 9 at the first floating wind turbine 2.
1. The installation vessel 5 lowers the dynamic cable on its «A&R wire» to (Abandonment and Recovery wire) transfer depth. At transfer depth the pull-in winch is tensioned to take out slack in the messenger wire.
2. The installation vessel 5 continues to pay out on the A&R (Abandonment and Recovery) wire and starts to pull-in the second end of the inter-array dynamic cable 3 with pull-in winch 6 following the lay table for the operation. The subsea operation is typically monitored by an ROV.
3. When the catenary load of the inter-array dynamic cable is transferred to the pull-in winch 6 the A&R (Abandonment and Recovery) wire is ready to be disconnected.
4. The installation vessel continue cable pull-in after A&R (Abandonment and Recovery) wire is disconnected. An ROV is typically used to disconnect the A&R wire.

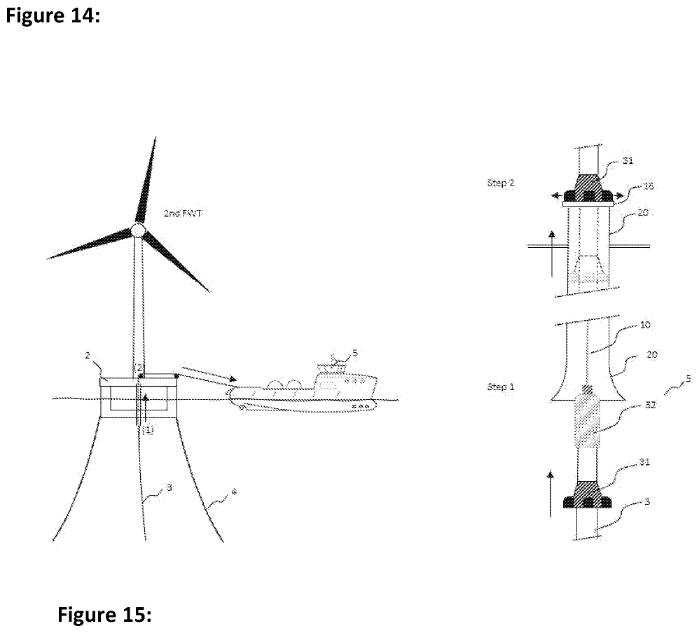

FIG. 15 illustrates a pull-in and hang-off of the inter array dynamic cable 3 end at the second floating wind turbine 2. In step 1, the inter-array dynamic cable is pulled-in through a guide tube 20 on the floating wind turbine 2. In step 2 the inter-array dynamic cable is hung-off on the floating wind turbine.

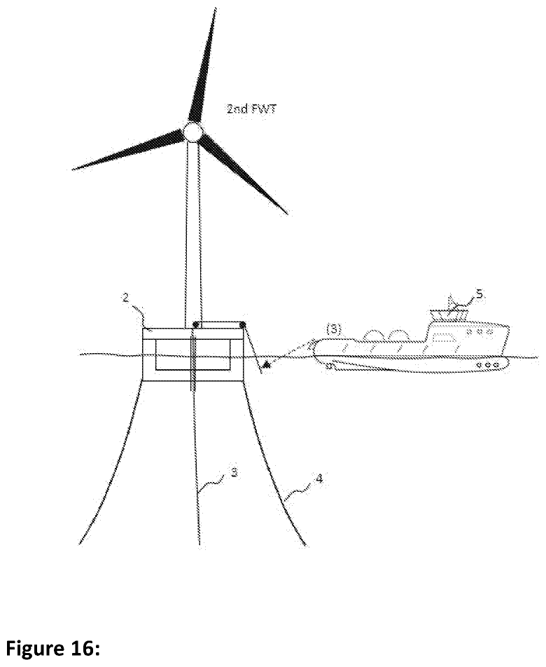

In FIG. 16, the messenger wire/pull-in wire is disconnected from the installation vessel 5. On the floating wind turbine, the second inter-array dynamic cable end pull-in and hang-off operation are similar to the first inter-array dynamic cable end pull-in and hang-off operation. Until the hang-off clamp is pulled past the guide tube hang-off flange/interface the operation can be reversed.

Recovery and Pull-In from Wet Store

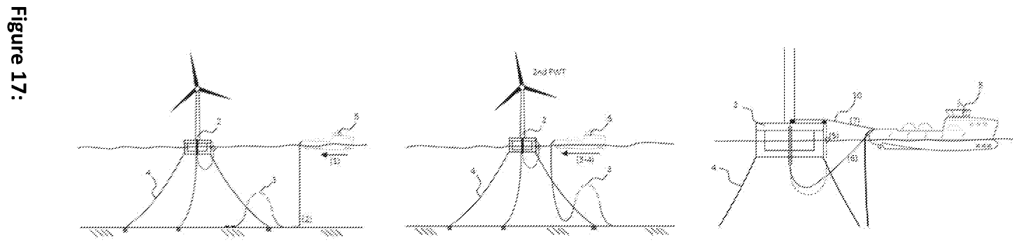

FIG. 17A-C illustrates recovery and pull-in of an inter array dynamic cable from a wet store. The wet store is at the seabed.

### Stage 1:

1. Position installation vessel 5 above topside end of the wet stored inter-array dynamic cable.
2. Deploy and connect recovery wire to the inter-array dynamic cable.

### Stage 2:

3. Start to recover inter-array dynamic cable, monitor configuration and touch down point (TDP) of the inter-array dynamic cable by typically an ROV.
4. Move installation vessel in position for the pull-in operation close to the floating wind turbine.

### Stage 3:

5. Pick up the pre-installed messenger wire on the floating wind turbine.
6. Connect messenger wire end routed subsea to the inter-array dynamic cable.
7. Connect messenger wire end routed topside to pull-in winch.

Continue cross-haul, pull-in and hang-off in the same way as described for the second inter-array dynamic cable end cross-haul, in a pull-in and hang-off operation as described above.

The steps illustrated in FIGS. 9-17 are examples only and the remote pull-in concept may also be performed in other steps following the lay plan of the dynamic cable installation. Alternative methods may be envisaged depending upon the vessel and the lay spread, the configuration of the dynamic cable and the interface on the floating installation. The remote pull-in concept may be adapted to different variants and scenarios.

The examples are illustrated and described for a floating wind turbine, but the dynamic cable pull-in concept may also be used for other floating installations to be provided with a dynamic cable and the examples and the invention is not limited to a floating wind turbine. The concept may be used on other floating installations where it is possible to pre-install and integrate equipment and instrumentation as described above for the FWT on the floating installation.

In the examples an inter array dynamic cable is connected between the floating wind turbines, but this is only an example and dynamic cables in general may be installed by use of the remote pull-in concept described above. The remote pull-in winch concept may also be used for installation of dynamic cables to and/or between floating installations, in particular where there are many floating installations that are to be connected together by a dynamic cable. The pull-in winch concept for performing a pull-in operation may also be used on floating installations where it is difficult or dangerous to get personnel and equipment onboard/offboard the floating installation. In some floating installations the space for larger necessary equipment, e.g. a winch performing a pull-in operation, is limited or not available. The space on the floating installation may also be limited or too small for personnel needed during the pull-in operation.

The process of cable installation may be carried out by the described method above by controlling the relative position of the FWT and the vessel through dynamic positioning on the vessel combined with winch control and position signal from the FWT. Thus, the cable installation may be controlled by monitoring the distance between the vessel and the FWT. The movement of the pull-in wire and cable may alternatively be monitored versus a reference point on the FWT and compensated by the pull-in system.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1.-42. (canceled)

43. A system for remote cable pull-in of a dynamic cable to a floating wind turbine from a vessel, the system comprising:
a floating wind turbine comprising:
a pull-in wire attachable to a dynamic cable to be connected to the floating wind turbine; and
a vessel for performing a dynamic cable pull-in operation for connecting the dynamic cable to the floating wind turbine, wherein the pull-in wire is attachable to the dynamic cable, the vessel is adapted for pulling the pull-in wire and the attached dynamic cable to the floating wind turbine,
wherein the system is adapted for compensating a relative movement between the vessel and the floating wind turbine during the pull-in operation.

44. The system of claim 43, wherein the system is adapted to compensate for movement of the pull-in wire relative to the floating wind turbine as may result from a variable distance between the vessel and floating wind turbine caused by vertical and/or lateral motions of either the vessel and/or the floating wind turbine.

45. The system of claim 43, further comprising a sensor for measuring the distance between the floating wind turbine and the vessel.

46. The system of claim 43, wherein a relative movement between the vessel and the floating wind turbine is estimated indirectly by using data from at least two sensors, where at least one first sensor is arranged on the vessel and the at least one second sensor is arranged on the floating wind platform.

47. The system of claim 43, wherein the vessel is provided with a dynamic positioning system adapted for controlling the vessel based on at least one first input parameter.

48. The system of claim 43, wherein a winch control system is adapted for controlling a winch on the vessel based on at least one second input parameter.

49. The system of claim 47, wherein the at least one first input parameter comprises at least one of:
a position of the floating wind turbine; a position of the vessel; motions of the floating wind turbine including at least one of heave, sway, surge, roll, pitch and yaw; motions of the vessel including at least one of heave, sway, surge, roll, pitch and yaw; position of the pull-in wire and the dynamic cable; a tension in the dynamic cable; a tension in pull-in wire; a position of the pull-in wire relative to the floating wind turbine; a movement of the pull-in wire relative to the floating wind turbine; a position of the dynamic cable relative to the floating wind turbine; a movement of the dynamic cable relative to the floating wind turbine; and an output from the winch control system.

50. The system of claim 48, wherein the at least one second input parameter comprises at least one of:
a position of the floating wind turbine; a position of the vessel; motions of the floating wind turbine including at least one of heave, sway, surge, roll, pitch and yaw; motions of the vessel including at least one of heave, sway, surge, roll, pitch and yaw; a position of the pull-in wire and the dynamic cable; a tension in the dynamic cable; a tension in pull-in wire;
a position of the pull-in wire relative to the floating wind turbine; a movement of the pull-in wire relative to the floating wind turbine; a position of the dynamic cable relative to the floating wind turbine; a movement of the dynamic cable relative to the floating wind turbine; and an output from the dynamic positioning system.

51. The system of claim 43, wherein compensating the relative movement between the vessel and the floating wind turbine during the pull-in operation is performed by the winch or the winch and the dynamic positioning system.

52. The system of claim 43, further comprising at least one inertial navigation system.

53. The system of claim 43, wherein the system further comprising at least one of a satellite navigation system or an inertial measurement unit.

54. The system of claim 53, wherein the inertial measurement unit is at least one of a motion reference unit and a motion gyro compass.

55. The system of claim 43, further comprising at least one second sensor for monitoring a hang-off area on the floating wind turbine for the dynamic cable.

56. The system of claim 43, further comprising:
a first communication system adapted for communicating at least one sensor signal from the floating wind platform to the vessel; and
a second communication system on the vessel for receiving the at least one sensor signal.

57. The system of claim 55, wherein the first communication system and the second communication system are preferably a marine broad band radio.

58. A floating wind turbine comprising:
a pull-in wire attachable to a dynamic cable to be connected to the floating wind turbine;
wherein the pull-in wire is attachable to a vessel for performing a pull-in operation of the dynamic cable to the floating wind turbine and wherein the vessel is adapted for compensating a relative movement between the floating wind turbine and the vessel during the pull-in operation.

59. The floating wind turbine of claim 58, wherein the vessel is adapted to compensate for movement of the pull-in wire relative to the floating wind turbine as may result from a variable distance between the vessel and floating wind turbine caused by vertical and/or lateral motions of either the vessel and/or the floating wind turbine.

60. The floating wind turbine of claim 58, further comprising a sensor for measuring the distance between the floating wind turbine and the vessel.

61. The floating wind turbine of claim 58, further comprising at least one inertial navigation system.

62. The floating wind turbine of claim 58, further comprising at least one of a satellite navigation system and an inertial measurement unit, preferably being a motion reference unit or a motion gyro compass.

63. The floating wind turbine of claim 58, further comprising at least one sensor for monitoring a hang-off area for the dynamic cable.

64. The floating wind turbine of claim 63, wherein the at least one sensor is adapted to provide a signal when the dynamic cable is in a final hang-off position.

65. The floating wind turbine of claim 58, further comprising a hang-off arrangement adapted for hang-off of the dynamic cable to be pulled-in and connected to the floating wind turbine.

66. The floating wind turbine of claim 58, further comprising a communication system, preferably a marine broad band radio, adapted for communicating at least one signal from the floating wind turbine to the vessel.

67. A vessel for performing a dynamic cable pull-in operation for connecting a dynamic cable to a floating wind turbine provided with a pull-in wire, wherein the pull-in wire is attachable to the dynamic cable, the vessel comprising a winch adapted for pulling the pull-in wire for pulling in the dynamic cable to the floating wind turbine, wherein the vessel is adapted for compensating a relative movement between the floating wind turbine and the vessel during the pull-in operation.

68. The vessel of claim 67, wherein the vessel is adapted to compensate for movement of the pull-in wire relative to the floating wind turbine as may result from a variable distance between the vessel and the floating wind turbine caused by vertical and/or lateral motions of either the vessel and/or the floating wind turbine.

69. The vessel of claim 67, further comprising a sensor for measuring the distance between the floating wind turbine and the vessel.

70. The vessel of claim 67, further comprising a dynamic positioning system adapted for controlling the vessel based on at least one first input parameter.

71. The vessel of claim 67, wherein a winch control system is adapted for controlling the winch based on at least one second input parameter.

72. The vessel of claim 70, wherein the at least one first input parameter further comprises at least one of:
a position of the floating wind turbine; a position of the vessel; motions of the floating wind turbine including at least one of heave, sway, surge, roll, pitch and yaw; motions of the vessel including at least one of heave, sway, surge, roll, pitch and yaw; a position of the pull-in wire and the dynamic cable; a tension in the dynamic cable; a tension in pull-in wire; a position of the pull-in wire relative to the floating wind turbine; a movement of the pull-in wire relative to the floating wind turbine; a position of the dynamic cable relative to the floating wind turbine; a movement of the dynamic cable relative to the floating wind turbine; and anoutput from the winch control system.

73. The vessel of claim 71, wherein the at least one second input parameter further comprises at least one of:
a position of the floating wind turbine; a position of the vessel; motions of the floating wind turbine including at least one of heave, sway, surge, roll, pitch and yaw; motions of the vessel including at least one of heave, sway, surge, roll, pitch and yaw; a position of the pull-in wire and the dynamic cable; a tension in the dynamic cable; a tension in pull-in wire; a position of the pull-in wire relative to the floating wind turbine; a movement of the pull-in wire relative to the floating wind turbine; a position of the dynamic cable relative to the floating wind turbine; a movement of the dynamic cable relative to the floating wind turbine; and an output from the dynamic positioning system.

74. The vessel of claim 67, wherein compensating the relative movement between the vessel and the floating wind turbine during the pull-in operation is performed by the winch or the winch and the dynamic positioning system.

75. The vessel of claim 67, further comprising:
a communication system, preferably a marine broadband radio, for receiving at least one sensor signal from the floating wind turbine.

76. A method for performing a cable pull-in of a dynamic cable to a floating wind turbine according to the system of claim 43, the method comprising:
attaching the dynamic cable to a pull-in wire on the floating wind turbine;
pulling the pull-in wire by the vessel until the dynamic cable is positioned in a hang-off arrangement on the floating wind turbine; and
compensating a relative movement between the floating wind turbine and the vessel during the pull-in operation.

77. The method of claim 76, wherein the system is adapted to compensate for movement of the pull-in wire relative to the floating wind turbine as may result from a variable distance between the vessel and floating wind turbine caused by vertical and/or lateral motions of either the vessel and/or the floating wind turbine.

78. The method of claim 76, further comprising measuring a distance between the floating wind turbine and the vessel.

79. The method of claim 76, further comprising measuring a distance between an exit for the pull-in wire on the floating wind turbine and an entry for the pull-in wire on the vessel.

80. The method of claim 76, further comprising controlling the vessel by a dynamic positioning system based on at least one first input parameter.

81. The method of claim 77, further comprising controlling the winch by a winch control system based on at least one second input parameter.

82. The method of claim 80, wherein the at least one first input parameter comprises at least one of:
a position of the floating wind turbine; a position of the vessel; motions of the floating wind turbine including at least one of heave, sway, surge, roll, pitch and yaw; motions of the vessel including at least one of heave, sway, surge, roll, pitch and yaw; a position of the pull-in wire and the dynamic cable; a tension in the dynamic cable; a tension in pull-in wire; a position of the pull-in wire relative to the floating wind turbine; a movement of the pull-in wire relative to the floating wind turbine; a position of the dynamic cable relative to the floating wind turbine; a movement of the dynamic cable relative to the floating wind turbine; and output from the winch control system.

83. The method of claim 81, wherein the at least one second input parameter comprises at least one of:
a position of the floating wind turbine; a position of the vessel; motions of the floating wind turbine including at least one of heave, sway, surge, roll, pitch and yaw; motions of the vessel including at least one of heave, sway, surge, roll, pitch and yaw; a position of the pull-in wire and the dynamic cable; a tension in the dynamic cable; a tension in pull-in wire; a position of the pull-in wire relative to the floating wind turbine; a movement of the pull-in wire relative to the floating wind turbine; a position of the dynamic cable relative to the floating wind turbine; a movement of the dynamic cable relative to the floating wind turbine; and an output from the dynamic positioning system.

84. The method of claim 78, wherein compensating the relative movement between the vessel and the floating wind turbine during the pull-in operation is performed by the winch or the winch and the dynamic positioning system.
